(19) United States
(12) Patent Application Publication
(10) Pub. No.: US 2010/0121618 A1
(43) Pub. Date: May 13, 2010

(54) SUBJECT MODELLING

(75) Inventor: Nigel Greenwood, Fig Tree Pocket, Queensland (AU)

Correspondence Address: SCULLY SCOTT MURPHY & PRESSER, PC, 400 GARDEN CITY PLAZA, SUITE 300, GARDEN CITY, NY, 11530, US

(73) Assignee: Neurotech Research Pty Limited, Fig Tree Pocket, Queensland (AU)

(21) Appl. No.: 12/530,533

(22) PCT Filed: Mar. 9, 2007
(86) PCT No.: PCT/AU07/00301

§ 371 Date: Nov. 9, 2009

Related U.S. Application Data
(60) Provisional application No. 60/782,560, filed on Mar. 15, 2006.

(30) Foreign Application Priority Data
Mar. 10, 2006 (AU) 2006901231

(51) Int. Cl. G06G 7/60; G06F 17/10

(52) U.S. Cl. 703/2; 703/11

(57) ABSTRACT

A method of modelling the biological response of a biological subject. The method includes, in a processing system, for a model including one or more equations and associated parameters, comparing at least one measured subject attribute and at least one corresponding model value. The model is then modified in accordance with results of the comparison to thereby more effectively model the biological response.

### BACKGROUND OF THE INVENTION

The present invention relates to a method and apparatus for use in modelling the biological response of a biological subject, and in particular to a method and apparatus that can be used for generating a model representing the effect of one or more conditions on a living body.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Currently, it is known to determine medication programs to allow drugs to be administered for different medical conditions. However the determination of the drug programs typically requires years of experimentation. Even then the regimes are typically fairly simplistic and rely on the patient taking specified quantities of medication at various time intervals.

WO2004027674 describes a process for using a derived model to allow treatment program for a subject. However, current techniques for model development are limited.

Model Reference Adaptive Control (MRAC) is a technique used for controlling physical objects in accordance with predictive models. In particular, the process involves taking a complicated bit of machinery or electronics, often referred to as a “plant”, that is not easily modelled, and constraining its behaviour so that it behaves in a manner that is increasingly similar to a theoretical model that the control process uses as its “reference”.

This is commonly used for example to allow robot arms to be controlled using appropriate control algorithms. In this instance, each robot arm will react slightly differently to set commands, due to variations in physical and environmental factors, such as gear wear, or the like. To overcome this, MRAC operates by using a reference model of a robot arm and monitoring the operation of the actual arm for specified control commands, and then uses sensor feedback of this ensuing change of state to modify the control commands and/or model parameters, altering the arm's response, to ensure that there is concordance between the stipulated model behaviour and actual arm operation, when commanded by the control algorithms.

Within the field of MRAC as applied to robotics or electrical engineering, variations on the basic idea include “Identification” in an adaptive control context. If the reference model is sufficiently close in mathematical structure to that of the unknown robot dynamics, the process of modifying the model parameters to ensure concordance between the stipulated model behaviour and actual arm operation can be regarded as a process of estimating actual arm parameters within the context of the model structure. In its most extreme form, identification-based algorithms can be regarded as an “inversion” of conventional MRAC techniques, so that the model comes to track the plant rather than vice versa.

Woo, J. and Rootenberg J., (1975) Lyapunov Redesign of Model Reference Adaptive Control System for Long Term Ventilation of Lung, ISA Trans.; 14(1):89-98 describes conventional application of MRAC to an “iron lung” to regulate ventilation, and therefore is limited to application with a specific hardware configuration.

Palerm, C. C. R., Drug Infusion Control: an Extended Direct Model Reference Adaptive Control Strategy describes basic linear MRAC, mainly as applied to drug administration for diabetes. However, this is limited to a linear MRAC scheme and as biological systems are generally non-linear, this has limited application in generalised biological scenarios.

WO2004027674 provides a method of determining a treatment program for a subject. The method includes obtaining subject data representing the subject's condition. The subject data is used together with a model of the condition, to determine system values representing the condition. These system values are then used to determining one or more trajectories representing the progression of the condition in accordance with the model. From this, it is possible to determine a treatment program in accordance with the determined trajectories.

### SUMMARY OF THE PRESENT INVENTION

In a first broad form the present invention provides a method of modelling the biological response of a biological subject, the method including, in a processing system:
a) for a model including one or more equations and associated parameters, comparing at least one measured subject attribute and at least one corresponding model value; and,
b) modifying the model in accordance with results of the comparison to thereby more effectively model the biological response.

Typically the method includes:
a) determining a difference between the at least one measured subject attribute and the at least one corresponding model value; and,
b) modifying the model in accordance with the determined difference.

Typically the method includes, in the processing system, iteratively modifying the model until at least one of:
a) the difference is below a predetermined threshold;
b) the difference asymptotically approaches an acceptable limit; and,
c) the difference is minimised.

Typically the method includes, in the processing system:
a) determining a subject trajectory representing changes in the at least one measured subject attribute over time;
b) determining a model trajectory representing changes in the at least one corresponding model value over time; and,
c) performing the comparison by comparing the trajectories.

Typically the method includes, in the processing system, iteratively modifying the model until the model and subject trajectories converge.

Typically the method includes:
a) using control inputs to induce at least one of a perturbation and agitation of the subject into a non-equilibrium condition; and,
b) determining at least one measured subject attribute under the non-equilibrium condition.

Typically the method includes, in the processing system:
a) forming a linear error equation representing a difference between a desired state of the subject and an actual state; and,
b) constructing a control algorithm to minimise the error equation.

Typically the method includes, in the processing system, at least one of:
a) using Lyapunov stability methods to ensure convergence of subject and model behaviour through use of one or more Lyapunov functions; and,
b) using a derivative of one or more Lyapunov functions to impose convergence of subject and model behaviour.

Typically the method includes, in the processing system, modifying the model using at least one of:
a) model reference adaptive control-based methods;
b) Lyapunov stability-based methods; and,
c) in the event that the subject exhibits mathematically chaotic behaviour, using data obtained from surface-of-section embedding techniques.

Typically the method includes, in the processing system:
a) determining a Lyapunov function;
b) determining a numerical value of a derivative of a Lyapunov function, and
c) using the Lyapunov function to modify at least one model value.

Typically the method includes, in the processing system, at least one of the following:
a) using the existence of a Lyapunov function as the mathematical basis for employing other algorithms to modify at least one model value; and,
b) in the case of chaotic behaviour being exhibited by the subject, using surface-of-section embedding techniques as the mathematical basis for employing other algorithms to modify at least one model value.

Typically the method includes, in the processing system, at least one of:
a) using pattern-finding or optimisation algorithms to at least one of:
   i) select one of a number of predetermined Lyapunov functions; and/or,
   ii) optimise a Lyapunov function; and/or
   iii) optimise the derivative of a Lyapunov function,
b) searching candidate Lyapunov functions to determine a function resulting in the best improvement to the model; and,
c) at least one of:
   i) searching the derivatives of candidate Lyapunov functions to determine a function resulting in the best improvement to the model; and
   ii) employing candidate derivatives without explicitly invoking the underlying Lyapunov function.

Typically the method includes, in the processing system, using pattern-finding or optimisation algorithms to determine a function or related algorithms resulting in the best improvement to the model.

Typically the model is formed from at least one non-linear ordinary differential equation or difference equation.

Typically the model value includes at least one of:
a) State variable values representing rapidly changing attributes;
b) Parameter values representing slowly changing or constant attributes; and,
c) Control variable values representing attributes of the biological response that can be externally controlled.

Typically the method includes, in the processing system in the instance of mathematically-chaotic behaviour being exhibited by the subject, at least one of the following:
a) using the data obtained from surface-of-section embedding techniques to determine an improvement in the model within the domain of chaotic behaviour, by modifying at least one of the following:
   i) At least one equation; and,
   ii) At least one model value; and,
b) using the data obtained from surface-of-section embedding techniques, to determine an improvement in the model outside the domain of chaotic behaviour, by modifying at least one of the following:
   i) At least one equation; and,
   ii) At least one model value.

Typically the method includes, in the processing system:
a) determining a condition-independent base model; and,
b) updating the base model to determine a condition-specific model by modifying at least one of:
   i) at least one equation; and,
   ii) at least one model value.

Typically the method includes, in the processing system:
a) selecting a base model from a number of predetermined base models; and,
b) modifying the model to thereby simulate a condition within the subject.

Typically the base model is formed from at least one of:
a) biological components;
b) pharmacological components;
c) pharmacodynamic components; and,
d) pharmacokinetic components.

Typically the measured subject attribute is the subject status and the model value is a model output value indicative of the modelled subject status.

Typically the subject is at least one of a patient, an animal or an in vitro tissue culture.

Typically the model models a condition including at least one of:
a) Degenerative diseases such as Parkinson's or Alzheimer's;
b) Disorders involving dopaminergic neurons;
c) Schizophrenia;
d) Bipolar disorders/manic depression;
e) Cardiac disorders;
f) Myasthenia gravis;
g) Neuro-muscular disorders;
h) Cancerous and tumorous cells and related disorders;
i) HIV/AIDS and other immune or auto-immune system disorders;
j) Hepatic disorders;
k) Athletic conditioning;
l) Pathogen related conditions;
m) Viral, bacterial or other infectious diseases;
n) Leukemia;
o) Poisoning, including snakebite and other venom-based disorders;
p) Insulin-dependent diabetes;
q) Clinical trialling of drugs;
r) Any other instances of medication or drug administration to a subject, such that repeated doses are administered over time to maintain drug or ligand concentration to a desired level or within an interval of levels, in the presence of dissipative pharmacokinetic processes such as those of uptake or absorption, distribution or transport, metabolism or elimination;
s) Reconstruction of cardiac rhythms, function, arrhythmia or other cardiac output;
t) Drug-based control of arterial pressure.

Typically the method includes, in the processing system, using the model to perform at least one of:
a) determining a health status of the subject;
b) diagnosing a presence, absence or degree of a condition;
c) treating a condition; and,
d) determining at least one biological attribute for the subject.

In a second broad form the present invention provides apparatus for modelling the biological response of a biological subject, the apparatus including a processing system for:
a) for a model including one or more equations and associated parameters, comparing at least one measured subject attribute and at least one corresponding model value; and,
b) modifying the model in accordance with results of the comparison to thereby more effectively model the biological response.

In a third broad form the present invention provides a computer program product for modelling the biological response of a biological subject, the computer program product being formed from computer executable code, which when executed using a suitable processing system causes the processing system to:
a) for a model including one or more equations and associated parameters, compare at least one measured subject attribute and at least one corresponding model value; and,
b) modify the model in accordance with results of the comparison to thereby more effectively model the biological response.

In a fourth broad form the present invention provides a method for use in at least one of treating or diagnosing a subject, the method including modelling a biological response of a biological subject, using a processing system that:
a) for a model including one or more equations and associated parameters, compares at least one measured subject attribute and at least one corresponding model value;
b) modifies the model in accordance with results of the comparison to thereby more effectively model the biological response; and,
c) using the model to at least one of treat and diagnose a condition within the subject.

It will be appreciated that the broad forms of the invention may be used individually or in combination, and may be used in diagnosing the presence, absence or degree of medical conditions, treating conditions, as well as determining a heath status for a subject.

### BRIEF DESCRIPTION OF THE DRAWINGS

An example of the present invention will now be described with reference to the accompanying drawings, in which:-

FIG. 1 is a flow chart of an example of a process for determining a model;

FIG. 2 is schematic diagram of an example of the functional elements used in determining a model;

FIG. 3 is a schematic diagram of an example of a processing system;

FIG. 4 is a flow chart of a specific example of a process for determining a model; and,

FIG. 5 is a schematic diagram of a distributed architecture.

### DETAILED DESCRIPTION OF THE PREFERRED EMBODIMENTS

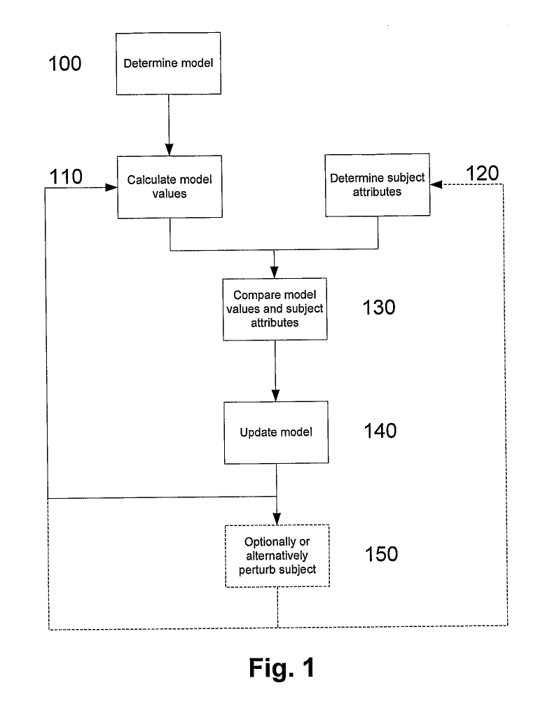

An example of a process for determining a subject model will now be described with reference to FIG. 1.

The subject model is intended to model the biological response of the subject. This allows the model to be used for example, to determine the health status, or the presence, absence or degree of one or more medical conditions. This also allows the biological effect of a condition to be modelled, allow derivation of treatment regimes or the like. The manner in which the model is derived will now be described in more detail.

For the purpose of the following examples, it is assumed that the subject is a human patient, but it will be appreciated that the techniques may be applied to any form of biological system including, but not limited to, patients, animals, in vitro tissue cultures, or the like. It will also be assumed that the process is being used to derive a model specific to a condition suffered by the subject, although it will be appreciated that this is not essential.

At step 100 a base subject model is determined. The model is typically in the form of a set of Ordinary Differential Equations (ODEs) or Difference Equations (DEs) that can be used to express basic responses of a subject. In this regard, the ODEs or DEs typically utilise a mixture of variables and parameters to represent the condition within the subject, including:
State variable values representing rapidly changing attributes;
Parameter values representing slowly changing or constant attributes; and,
Control variable values representing attributes of the condition that can be externally controlled.

The model can be determined in any one of a number of ways depending on the preferred implementation. For example, this can be achieved by selecting a predetermined model that is subject and/or condition specific. Alternatively, a model may be a default preliminary model, or can be selected from a range of different model components, depending on the condition or subject being modelled. The model could be derived manually by an operator.

At step 110 the model is used to calculate model values. The values can include any of the parameter or variable values, as well as a model output representing the overall expected status of the subject. The model values are typically calculated by applying one or more input values to the model (“model input values”) that represent the subject in some way. At the most basic level this can merely represent the progression of time, but can also take into account the subject environment, and any control inputs provided to the subject, such as medication, or the like.

Simultaneously, prior to, or in conjunction with this, the measurements indicative of subject attributes, such as the actual status of the relevant subject are determined. The subject attributes can be measured over a predetermined time period in advance of analysing the model, or alternatively can be measured in real time whilst the model is being generated.

In either case, at step 130, model values and subject attributes are compared to determine if the model is accurately represents the subject.

Thus, this typically involves measuring various physical parameters of the subject, such as biological markers, physical characteristics, or the like, and then comparing these to equivalent model values. This can therefore involve examining the overall status of the subject and comparing this to a model output. Alternatively, this can involve examining certain measurable attributes, such as concentrations of active substances and comparing this to a value derived from the model, which represents a theoretical concentration of the substance.

At step 140, the result of this comparison is used to modify or update the model to allow this to more accurately represent the subject and/or condition.

Typically this process will involve updating model parameter, state variable or control variable values, associated with the ODEs or DEs, although alternatively this may involve generating new, or replacement ODEs or DEs to update the model.

In any event, by iteratively performing this process it is possible to minimise or at least reduce variations between the model values and corresponding measured subject attributes so that the model more accurately represents the biological response of the subject. This can then be used to determine a health status and/or any medical conditions from which the subject is suffering.

As an additional option, it is possible to perturb or agitate the status of the subject through the use of external control inputs, such as providing medication to a patient, as shown at step 150. This allows further checks of the model to be performed, or generates further data. In this case, following application of the control inputs to the subject, subject attributes will be remeasured at step 120. The model is also modified to simulate the application of the control, and model values recalculated at step 110, before steps 130 and 140 are repeated.

It will be appreciated from this that the application of control inputs may be performed at any stage, including prior to any model value determination, as will be described in more detail below.

Once this is completed this allows the model to be used for any one of a number of different purposes. This can include, for example, using the model parameters to derive information regarding the subject that would not otherwise be easily or practicably measurable. Additionally the model can be used as a basis for a control program as described for example in co-pending International Patent Application No. WO2004027674.

Accordingly, the above described process allows a patient or other subject to be monitored, with the results of the monitoring being used to configure a model. This is achieved by comparing model predictions to the measured values, and then modifying the model to thereby minimise variations therebetween. Once the model is sufficiently accurate, this allows the model to be used in predicting the effects of medication regimes, or the like.

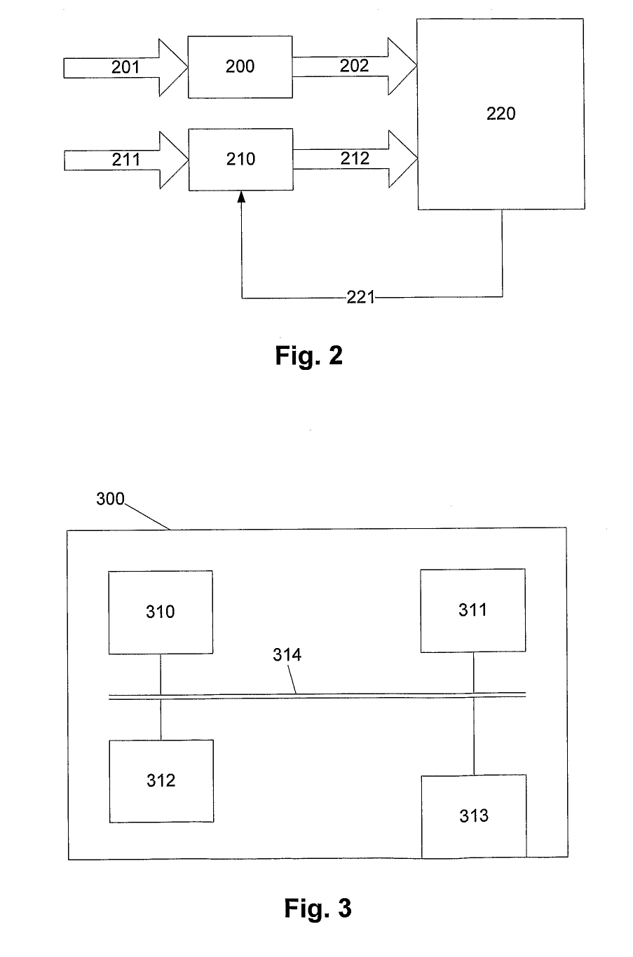

An example of the functional relationship of the subject and model is shown in more detail in FIG. 2.

In this example, a subject 200 has associated control inputs 201 in the form of medication or other external stimulus, with measured attributes being determined as an output at 202.

Similarly, the subject model 210 has corresponding model inputs 211 and model outputs 212. In this instance, the model inputs 211 typically correspond to control variable values representing the control inputs 201 applied to the subject 200. Similarly, the output 212 is typically formed from a combination of one or more state variable or parameter values obtained by applying the control variable values 211 to the model 210.

A control system is provided at 220 to analyse the measured attributes 202 and the model output 212 and provide feedback 221 to allow the model to be updated. This is typically achieved using some form of Model Reference Adaptive Control (MRAC) or related process of Identification, as will be described in more detail below.

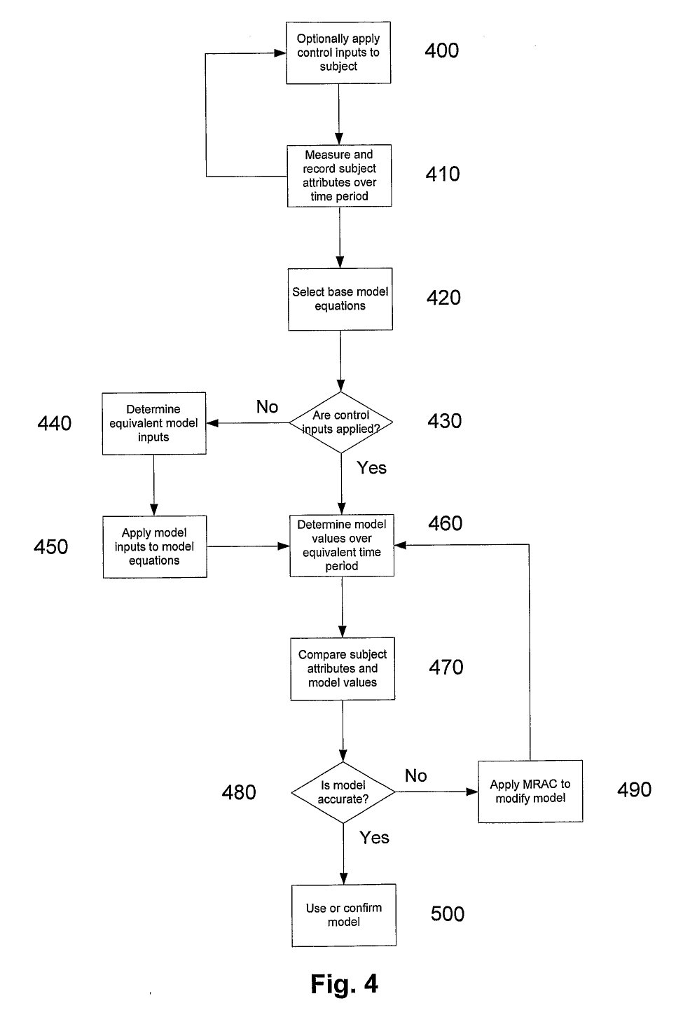

A person skilled in the art will appreciate that aspects of the above outlined procedure may be performed manually. However, in order to achieve this it will be necessary for an individual to perform significantly complicated mathematics in order to analyse the measured subject attributes and calculate a suitable model. Accordingly, this process is typically performed at least in part utilising a processing system. In particular, the processing system is typically adapted to operate as the control system, as well as implementing the model 210. It will be appreciated from this that any suitable form of processing system may be used, and an example is shown in FIG. 3.

In this example the processing system 300 includes a processor 310, a memory 311, an input/output device 312, such as a keyboard, video display, or the like, and an external interface 313, interconnected via a bus 314.

In use the memory 311 will operate to store algorithms used in performing the comparison at step 130 and to allow update of model values at step 140. The memory 311 may also store parameter and variable values, as well as ODEs or DEs, associated with the model under consideration. Similarly, the processor 310 typically executes the stored algorithms to compare the subject's measured attributes to the model values and perform the necessary updates to the model.

Required inputs, such as the measured attributes, model details, and control inputs may be provided in any one of a number of manners. This can include receiving monitored or measured values from remote equipment via the external interface 313, or by having the information entered manually via the I/O device 312.

Thus for example, in the case of the measured attributes being derived from an MRI scan, the scan may be supplied directly to the processing system, which is then adapted to analyse the scan to extract the required information. Alternatively, a medical practitioner may be required to evaluate the scan to determine information such as the total brain cell mass therefrom, with this information then being submitted to the processing system.

Similarly, the models may be based on base models or model components that are input manually or retrieved from a store, such as the memory 311, a remote database, or the like.

It will therefore be appreciated that the computer system may be any form of computer system such as a desktop computer, laptop, PDA, or the like. However, as the level of processing required can be high, custom hardware configurations, such as a super computer or grid computing may be required.

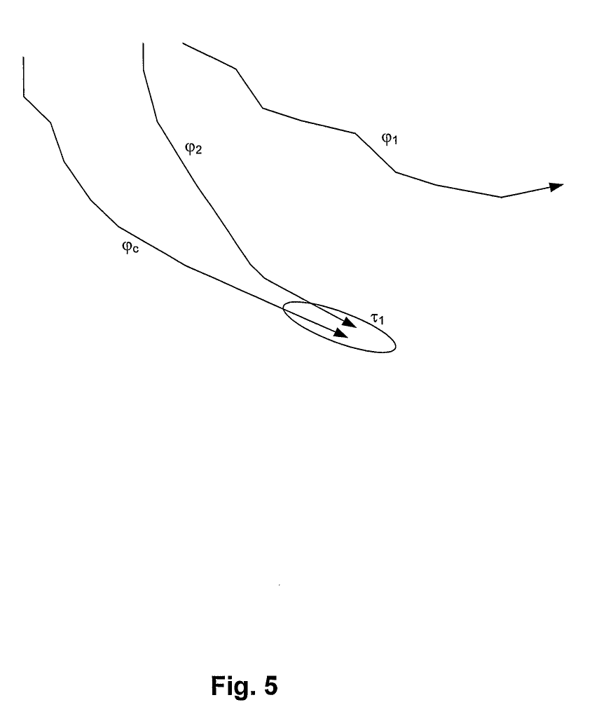

The process will now be described in more detail with respect to FIG. 4.

In this example, at step 400 control inputs are optionally applied to the subject, with the response of the subject, in the form of measured attributes, being determined and recorded over a time period at step 410.

Control inputs, where they exist may in any one of a number of forms, such as the introduction of a drug, or some other form of external stimulus. Control inputs may be set to null, or else actually implemented, depending on the circumstances.

The measured attributes can be in a range of forms, but typically is formed from a time-series of data representing one or a combination of:
the complete state of the system;
a fragment of the complete state of the system; and,
indirect measurements of one, some or all of the state variables.

It will be appreciated that the latter measurement can be achieved by measuring a related biological marker or response that is a function of the state variable of interest. Thus, for example, measuring the response of dopamine-responsive structures of a patient's eyes may serve as an indicator of dopamine concentration in the patient's cerebro-spinal fluid, when this dopamine concentration itself might not be easily or feasibly measured for practical reasons. Where relevant state variables cannot be measured for practical reasons, they are referred to as “hidden” variables.

This process can be repeated as often as required to generate a dataset for use in updating the model. Alternatively, or additionally, the steps 400 and 410 can be performed in conjunction with the remaining steps such that the model is updated in real time based on the current subject measurements, and this may depend on the manner in which the process is used. Thus for example, if this is used to model a patient suffering from a terminal condition, it may not be possible to collect a dataset in advance of the modelling due to time constraints.

At step 420 base model equations are selected. This may be performed by selecting from predetermined model components, such as physiological, pharmacokinetic or other biological model components, which are typically expressed as a system of ODEs. The model may be linearised, but this is typically of insufficient complexity to accurately model the condition within the subject, and accordingly, models are typically nonlinear.

The model will typically be in the form:

dz/dt=f(z, u,λ, t) (1)

where:
z is a state vector formed from the state variable values such that z εΔ⊂ [symbol]
Δ is a set of vectors of all possible state variable values
u is a control vector formed from control variable values such that u ε U ⊂ [symbol]
U is a set of vectors of all possible control variable values
λ is a parameter vector formed from the parameter values such that λεΛ⊂ [symbol]
Λ is a set of vectors of all possible parameter values
t is time

It will be appreciated that in this instance, the model is made specific to the subject and the associated condition by selection of appropriate state variable and parameter values. To achieve this, the values may be initially seeded with default values, with the values being modified as described below, to allow the model to accurately represent the subject.

In the above example, the control vector u represents various external factors that can be used to influence the progression of the condition, such as the application of medication, or the like. The influence of these factors can be taken into account by examining the control inputs provided at step 400. Accordingly, at step 430, once the initial model has been selected, it is determined if control inputs are applied to the subject. If control inputs, such as medication, have been applied to the subject, then at step 440 equivalent model inputs are determined, and then applied to the model equations at step 450. This is typically achieved by modifying control variable values.

Once this is completed, or otherwise in the event that control inputs are not provided, the model is used to derive output in the form of one or more model values, such as state variable or parameter values. They are calculated over a time period equivalent to that over which the subject attributes were measured at step 460. Thus, for example, if model inputs are provided, these will be modified as required over the time period to represent the control inputs applied to the subject. Otherwise, if control inputs are not applied, then the model output is simply based on the progression over time with no inputs.

At step 470, the processing system 300 compares the subject attributes and model outputs over the time period and determines if the model is sufficiently accurate at step 480.

This can be achieved in a number of manners, but is typically achieved by determining if the difference or “error” between the measured attributes and the model values approach or fall below some acceptable limit or threshold. Thus, for example, this can involve examining the overall status of the subject and comparing this to an overall model output. Alternatively, the process can examine specific state variable and/or parameter values, and compare these to equivalent quantified biological attributes, to thereby determine if there is suitable convergence between the model and the subject's actual physical status.

Convergence is usually determined by mapping the time-series values of either the parameter values or state variables and equivalent biological attributes into state-space or phase-space, where they form trajectories. Thus, the ODEs or DEs forming the model are solved for the given time period to determine the change in values of the relevant parameters and/or state variables. Thus, once the equations have been determined, this allows the system equations to be used to generate solution trajectories φ, such that:

φ(z, u, λ, t)⊂ [symbol] (2)

With the model representing the condition of the subject, the trajectories generated will represent a calculated route of progression of the condition within the subject, for the current model. By comparing this to measurements obtained from the subject, which represent the actual progression of the condition within the subject, this allows the accuracy of the model to be assessed.

In this example, the model and the subject's physical status are said to converge if the trajectories representing the state variables of the model and the biological attributes of the subject converge appropriately in the designated space.

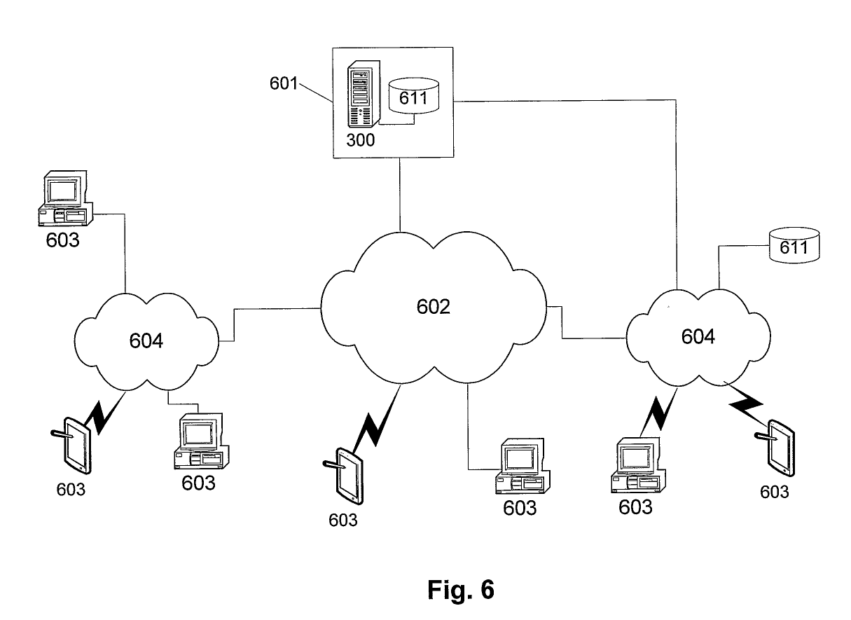

An example of this is shown in FIG. 5. In this example, the actual condition progression is represented by the trajectory φ_{c}. A first trajectory determined for the model progression is shown at φᵢ, where it is clear that the condition and model diverge, whereas a second model trajectory is shown at φ₂, where it is clear that the condition and model converge as required.

It will be appreciated that convergence of the overall state, state variable or parameter values with the measured attributes may be employed individually, as distinct processes, or else in combination.

If the model does not converge then at step 490 MRAC or related methods are applied to modify the model parameter or variable values, or the equations. This can be achieved in a number of manners, and will depend on factors, including for example the nature of the model and whether this is linear or non-linear.

In a non-linear example, convergence of the model with the subject responsiveness can be achieved through the use of Lyapunov stability methods, which in turn may be ensured through use of suitable Lyapunov functions, denoted Vᵢ, and appropriate manipulation of the derivatives of these functions. The Lyapunov function can be generated as required, can be a specified analytical Lyapunov function, or can be determined by searching among derivatives of one or more candidate Lyapunov functions.

However this is achieved, the Lyapunov function, by forcing convergence or asymptotic convergence between trajectories, can then be used to generate estimates for any one or combination of model parameter, state variable or control variable values, that result in the best match between the model's predicted output and the subject's measured output. These values can then be incorporated into the model.

In one example, this is achieved by having the processing system 300 select a set τ₁ of desirable target points z_{τ} for model dz/dt=f(z, u, λ, t) based on the trajectory φ_{c} of the actual measured subject attributes. Medical histories, case studies or examination of the trajectories can also be used to define constraints on the vector of possible parameter values λ and the state variable values z, such that λεΛ_{τ} and zεΔ, where Λ and Δ are bounded sets and Λ_{τ} is a compact set such that Λ_{τ}⊂Λ.

Two Liapunov functions Vᵢ are then designed to allow improved parameter or state variable values to be determined. These are typically designed such that

Vᵢ:Δ×λ= [symbol] (3)

where the operator symbol × in the above formula denotes a Cartesian product. In the case of V₁, this function is designed such that

τ₁⊂{zεΔ: V₁(z,λ)<κ∀λεζ_{τ}, for some specified κ>0} (4)

The function V₂ will be designed to impose convergence between the model parameter estimates and the parameter values of the subject. The Lyapunov condition

\dot{V}ᵢ=∇Vᵢf<0 (5)

is then imposed on each function, where the operator denotes a “dot product”. This simultaneously generates a medication regime that forces φ₂ and φ_{c} into τ₁, to converge while λ converges with the actual subject's parameter values.

A further variation is to use pattern-finding algorithms, or optimisation algorithms such as simulated annealing or genetic algorithms, to facilitate locating the best estimates for the values of model parameters in parameter-space, or to employ this process to optimise the relevant Lyapunov function and/or derivative for parameter identification. Similarly, pattern finding or optimisation algorithms can be used to assist in locating the best estimates for the values of hidden state variables in state-space, or employ this process to optimise the relevant Lyapunov function and/or derivative for reconstructing hidden state variables.

In addition or alternatively to this, it is also possible to use peturbations to the system by a fluctuating control input, to enhance or facilitate the identification process by pushing the system away from equilibrium conditions, as well as to address the presence of noise in the system.

For example, the model can also be adapted to take into account, or can be configured, using chaotic behaviour. The risk of mathematical chaos in a limited number of medical conditions, such as physical cardiac arrhythmia; is known. However the presence of mathematical chaos in clinical medication and in broader medical or biochemical applications is much wider than currently envisaged, for two reasons as outlined below.

Firstly, the majority of medication tasks in a clinical, other medical or biochemical context are, in mathematical terms, an exercise in forcing a dissipative or damped system. An example of this is using doses of medication, repeated regularly over time, to maintain the concentration of a ligand in an organ to a desired level or interval of levels, despite the ongoing presence of biological and physical processes, such as protein transport processes or enzyme-mediated reactions, that eliminate the ligand from the organ. Mathematically, the forcing of a dissipative system is known to be susceptible to the onset of chaotic behaviour, given appropriate parameter values;

Secondly, traditional pharmacokinetic formulations of drug uptake or absorption, distribution or transport, metabolism and elimination ignore a mathematical aspect that appears trivially obvious to biochemists: drug or ligand concentrations can never be negative. Consequently, a more accurate description of pharmacokinetic processes would include so-called “Heaviside” or “step” functions, mapping negative concentrations to zero. Incorporation of step functions in pharmacokinetic difference equations makes them non-invertible, which means that even low-dimension systems become more susceptible to chaos than indicated in usual models.

Reconstruction of phase-space information of a chaotic system, using delay coordinates and embedding, is a known process in advanced physics. Consider a system whose dynamics is described by a smooth (or piecewise smooth) low-dimensional set of ordinary differential equations,

dx(t)/dt=F(x(t)), for some function F.

The vector x(t) describes the state of the system, such that only one or more limited components of x(t) are able to be measured, or more generally, one or more scalar functions gᵢ(t) of the state of the system,

gᵢ(t)=Gᵢ(x(t)), for some scalar functions Gᵢ, where i=1, . . . n, some n≧1,

are able to be measured.

Then, using a surface-of-section map as described in the mathematical literature, e.g. E. Ott, Chaos in Dynamical Systems, Cambridge University Press 1993, it is possible to reconstruct information on the geometry of the attractor and the underlying dynamics of the system, including the function F, when the system is mathematically chaotic.

Accordingly, when the system, in this case the subject, is exhibiting chaotic behaviour, surface-of-section embedding techniques can be used to derive parameter values, and hence to refine the model. In particular, the data obtained from surface-of-section embedding techniques can be used to determine an improvement in the model by modifying either one of the equations used in the model, or one or more of the model values. This can be performed either in the domain of chaotic behaviour, or in the domain of non-chaotic behaviour.

The use of chaotic behaviour in this fashion may be required in a number of circumstances.

For example, the subject may be exhibiting mathematically chaotic behaviour when the process of forming the model is initially commenced.

Alternatively, in some circumstances, insufficient information may be obtainable purely from analysis of non-chaotic subject responses. In this case, by perturbing the subject, for example through the use of a suitable medication regime, mathematically chaotic behaviour can be induced within the subject.

It will be appreciated that analysis of subject response whilst undergoing mathematically chaotic behaviour may be used in addition to, or as an alternative to, the use of Lyapunov functions. For example, in some scenarios, use of Lyapunov functions alone will not allow sufficient refinement of the model, or allow sufficient parameters values to be determined, in which case, monitoring of the responsiveness in chaotic domains can be used to obtain or supplement required information.

Once regions of chaotic response have been determined, these can also be avoided in future, for example, through the use of a suitable medication regime, thereby assisting in subject treatment.

A further alternative is to construct the model from linear or linearisable systems of Ordinary Differential Equations (ODEs). In this instance, a linear error equation is formed, representing the difference between the desired state of the subject and the subject's actual state. The entire MRAC algorithm is then constructed around the problem of minimising this error.

In any event, once modifications have been determined, this allows the process to be repeated by returning to step 430 or step 460. This can be performed by comparing the model to the current dataset, as well as, or alternatively to comparing the model to a new dataset.

In any event, this process can be repeated until suitable convergence is achieved, at which point the model may be subsequently used at step 500. In particular, this allows the process to be performed iteratively until differences between the model and subject attributes asymptotically approach an acceptable limit or threshold.

It will be appreciated that the determined parameter values, state variable values, and/or equations may only be accurate over a short duration of time. Thus, as the condition progresses, it may be determined that the progression of the actual condition diverges from the trajectories predicted by the model. This may occur for a number of reasons.

For example, progression of the condition may cause an alteration in the model equations such that the model only accurately represents the condition for the current measured attributes. In this case, as the condition progresses, new equations, variable values, and/or parameter values, and hence new trajectories may need to be calculated to reflect the new subject condition. Additionally, the model parameters may be calculated based on limited information, such as a limited dataset, in which case it may be necessary to update the model as additional data becomes available.

Accordingly, the solution trajectories of the model can be repeatedly compared with the actual trajectory of the condition within the subject, allowing parameter, state variable, control variable values and/or equations to be recalculated, if convergence no longer holds.

The manner in which the model is used will depend on the particular circumstances. For example, the model can be used to determine the health status of a subject, for example by diagnosing the presence, absence or degree of conditions.

This can be achieved for example by deriving a model for the subject and then comparing the model to existing models to diagnose conditions. Additionally, or alternatively values of parameter values or state values can also be used in diagnosing conditions. Thus for example, deriving a state variable value representing dopamine levels can be used as an indicator as to the presence, absence or degree of conditions such as Parkinson's disease.

The model can also be used in treating patients, for example by deriving a medication regime, as described for example, in WO2004027674.

In addition to this, the model can be used to derive information regarding a subject that could not otherwise be actually or easily measured. Thus, for example, it is not always possible to determine certain physical or biological attributes of a subject. This can occur for example, if performing measurements is physically impossible, prohibitively expensive, or painful. In this instance, the model can be analysed to determine parameter or state variable values that correspond to the physical attribute of interest. Assuming that the model demonstrates suitable convergence with the subject, then this allows a theoretical value for the corresponding attribute to be derived.

In any event, by utilising feedback and in one example MRAC-based methods, this allows a model to be derived based on measured subject attributes. This is achieved by modifying the model in accordance with differences between measured subject attributes and corresponding model values. This can be performed iteratively to thereby minimise any variations, or at least reduce these to an acceptable level.

Thus, by ensuring the error between the measurements of output data from the medical system and the predicted output from the model asymptotically approach some acceptable limit (usually zero), this allows acceptable models to be mathematically derived.

In contrast to the original form of Model Reference Adaptive Control (MRAC) approach which updates the physical system to correspond to the predictive model, this technique emphasises updating the model until it is a suitable representation of the physical system.

Architectures

It will be appreciated that the above method may be achieved in a number of different manners.

Thus, for example, a respective processing system 300 may be provided for each medical practitioner that is to use the system. This could be achieved by supplying respective applications software for a medical practitioner's computer system, or the like, for example on a transportable media, or via download. In this case, if additional models are required, these could be made available through program updates or the like, which again may be made available in a number of manners.

However, alternative architectures, such as distributed architectures, or the like, may also be implemented.

An example of this is shown in FIG. 6 in which the processing system 300 is coupled to a database 611, provided at a base station 601. The base station 601 is coupled to a number of end stations 603 via a communications network 602, such as the Internet, and/or via communications networks 604, such as local area networks (LANs). Thus it will be appreciated that the LANs 604 may form an internal network at a doctor's surgery, hospital, or other medical institution. This allows the medical practitioners to be situated at locations remote to the central base station 601.

In use the end stations 603 communicate with the processing system 300, and it will therefore be appreciated that the end stations 603 may be formed from any suitable processing system, such as a suitably programmed PC, Internet terminal, lap-top, hand-held PC, or the like, which is typically operating applications software to enable data transfer and in some cases web-browsing.

In this case, the data regarding the subject, such as the measured attribute values can be supplied to the processing system 300 via the end station 603, allowing the processing system 300 to perform the processing before returning a model to the end station 603.

In this case, it will be appreciated that access to the process may be controlled using a subscription system or the like, which requires the payment of a fee to access a web site hosting the process. This may be achieved using a password system or the like, as will be appreciated by persons skilled in the art.

Furthermore, information may be stored in the database 611, and this may be either the database 11 provided at the base station 601, the database 611 coupled to the LAN 604, or any other suitable database. This can also include measured subject attributes, determined models, base models, or components, example Lyapunov functions, or the like.

It will be appreciated that by analysing data collected for a number of subjects, this will allow more accurate models to be developed in an iterative process. Statistical analysis can also allow additional models to be developed, for example by analysing a range of age groups to create age-dependent models.

Variations

The techniques can be applied to any subject, and this includes, but is not limited to patients of human or other mammalian, or non-mammalian species and includes any individual it is desired to examine or treat using the methods of the invention. Suitable subjects include, but are not restricted to, primates, livestock animals (e.g., sheep, cows, horses, donkeys, pigs), laboratory test animals (e.g., rabbits, mice, rats, guinea pigs, hamsters), companion animals (e.g., cats, dogs) and captive wild animals (e.g., foxes, deer, dingoes).

It will also be appreciated that the techniques can be used in vitro to examine the reaction of specific samples. Thus for example, the techniques can be used to monitor the reaction of cells to respective environmental conditions, such as combinations of nutrients or the like, and then modify the combination of nutrients, to thereby alter the cells response.

Furthermore, it will be understood that the terms “patient” and “condition”, where used, do not imply that symptoms are present, or that the techniques should be restricted to medical or biological conditions per se. Instead the techniques can be applied to any condition of the subject. Thus, for example, the techniques can be applied to performance subjects, such as athletes, to determine the subject's response to training. This allows a training program to be developed that will be able to prepare the subject for performance events, whilst avoiding overtraining and the like.

Thus, it will be appreciated that the condition of the subject may be the current physical condition, and particularly the readiness for race fitness, with the treatment program being a revised training program specifically directed to the athlete's needs.

In the case of humans, the conditions to which the techniques are most ideally suited include conditions such as:
a) Degenerative diseases such as Parkinson's or Alzheimer's;
b) Disorders involving dopaminergic neurons;
c) Schizophrenia;
d) Bipolar disorders/manic depression;
e) Cardiac disorders;
f) Myasthenia gravis;
g) Neuro-muscular disorders;
h) Cancerous and tumorous cells and related disorders;
i) HIV/AIDS and other immune or auto-immune system disorders;
j) Hepatic disorders;
k) Athletic conditioning;
l) Pathogen related conditions;
m) Viral, bacterial or other infectious diseases;
n) Leukemia;
o) Poisoning, including snakebite and other venom-based disorders;
p) Insulin-dependent diabetes;
q) Clinical trialling of drugs;
r) Any other instances of medication or drug administration to a subject, such that repeated doses are administered over time to maintain drug or ligand concentration to a desired level or within an interval of levels, in the presence of dissipative pharmacokinetic processes such as those of uptake or absorption, distribution or transport, metabolism or elimination;
s) Reconstruction of cardiac rhythms, function, arrhythmia or other cardiac output;
t) Drug-based regulation of arterial pressure;
u) Other disorders or diseases whose significant processes are capable of being reduced to a mathematical model.

However, it will be appreciated that the process can be implemented with respect to any condition for which it is possible to construct a mathematical model of the condition. This is not therefore restricted to medical conditions, although the techniques are ideally suited for the application to conditions such as diseases or other medical disorders.

Persons skilled in the art will appreciate that numerous variations and modifications will become apparent. All such variations and modifications which become apparent to persons skilled in the art, should be considered to fall within the spirit and scope that the invention broadly appearing before described.

1) A method of modelling the biological response of a biological subject, the method including, in a processing system:
a) for a model including one or more equations and associated parameters, comparing at least one measured subject attribute and at least one corresponding model value; and,
b) modifying the model in accordance with results of the comparison to thereby more effectively model the biological response.

2) A method according to claim 1, wherein the method includes:
a) determining a difference between the at least one measured subject attribute and the at least one corresponding model value; and,
b) modifying the model in accordance with the determined difference.

3) A method according to claim 2, wherein the method includes, in the processing system, iteratively modifying the model until at least one of:
a) the difference is below a predetermined threshold;
b) the difference asymptotically approaches an acceptable limit; and,
c) the difference is minimised.

4) A method according to claim 1, wherein the method includes, in the processing system:
a) determining a subject trajectory representing changes in the at least one measured subject attribute over time;
b) determining a model trajectory representing changes in the at least one corresponding model value over time; and,
c) performing the comparison by comparing the trajectories.

5) A method according to claim 4, wherein the method includes, in the processing system, iteratively modifying the model until the model and subject trajectories converge.

6) A method according to claim 1, wherein the method includes:
a) using control inputs to induce at least one of a perturbation and agitation of the subject into a non-equilibrium condition; and,
b) determining at least one measured subject attribute under the non-equilibrium condition.

7) A method according to claim 1, wherein the method includes, in the processing system:
a) forming a linear error equation representing a difference between a desired state of the subject and an actual state; and,
b) constructing a control algorithm to minimise the error equation.

8) A method according to claim 1, wherein the method includes, in the processing system, at least one of:
a) using Lyapunov stability methods to ensure convergence of subject and model behaviour through use of one or more Lyapunov functions; and,
b) using a derivative of one or more Lyapunov functions to impose convergence of subject and model behaviour.

9) A method according to claim 1, wherein the method includes, in the processing system, modifying the model using at least one of:
a) model reference adaptive control-based methods;
b) Lyapunov stability-based methods; and,
c) in the event that the subject exhibits mathematically chaotic behaviour, using data obtained from surface-of-section embedding techniques.

10) A method according to claim 1, wherein the method includes, in the processing system:
a) determining a Lyapunov function;
b) determining a numerical value of a derivative of a Lyapunov function, and
c) using the Lyapunov function to modify at least one model value.

11) A method according to claim 1, wherein the method includes, in the processing system, at least one of the following:
a) using the existence of a Lyapunov function as the mathematical basis for employing other algorithms to modify at least one model value; and,
b) in the case of chaotic behaviour being exhibited by the subject, using surface-of-section embedding techniques as the mathematical basis for employing other algorithms to modify at least one model value.

12) A method according to claim 10, wherein the method includes, in the processing system, at least one of:
a) using pattern-finding or optimisation algorithms to at least one of:
i) select one of a number of predetermined Lyapunov functions; and/or,
ii) optimise a Lyapunov function; and/or
iii) optimise the derivative of a Lyapunov function,
b) searching candidate Lyapunov functions to determine a function resulting in the best improvement to the model; and,
c) at least one of:
i) searching the derivatives of candidate Lyapunov functions to determine a function resulting in the best improvement to the model; and
ii) employing candidate derivatives without explicitly invoking the underlying Lyapunov function.

13) A method according to claim 12, wherein the method includes, in the processing system, using pattern-finding or optimisation algorithms to determine a function or related algorithms resulting in the best improvement to the model.

14) A method according to claim 1, wherein the model is formed from at least one non-linear ordinary differential equation or difference equation.

15) A method according to claim 1, wherein the model value includes at least one of:
a) State variable values representing rapidly changing attributes;
b) Parameter values representing slowly changing or constant attributes; and,
c) Control variable values representing attributes of the biological response that can be externally controlled.

16) A method according to claim 1, wherein the method includes, in the processing system in the instance of mathematically-chaotic behaviour being exhibited by the subject, at least one of the following:
a) using the data obtained from surface-of-section embedding techniques to determine an improvement in the model within the domain of chaotic behaviour, by modifying at least one of the following:
i) At least one equation; and,
ii) At least one model value; and,
b) using the data obtained from surface-of-section embedding techniques, to determine an improvement in the model outside the domain of chaotic behaviour, by modifying at least one of the following:
i) At least one equation; and,
ii) At least one model value.

17) A method according to claim 1, wherein the method includes, in the processing system:
a) determining a condition-independent base model; and,
b) updating the base model to determine a condition-specific model by modifying at least one of:
i) at least one equation; and,
ii) at least one model value.

18) A method according to claim 16, wherein the method includes, in the processing system:
a) selecting a base model from a number of predetermined base models; and,
b) modifying the model to thereby simulate a condition within the subject.

19) A method according to claim 16, wherein the base model is formed from at least one of:
a) biological components;
b) pharmacological components;
c) pharmacodynamic components; and,
d) pharmacokinetic components.

20) A method according to claim 1, wherein the measured subject attribute is the subject status and the model value is a model output value indicative of the modelled subject status.

21) A method according to claim 1, wherein the subject is at least one of a patient, an animal or an in vitro tissue culture.

22) A method according to claim 1, wherein the model models a condition including at least one of:
a) Degenerative diseases such as Parkinson's or Alzheimer's;
b) Disorders involving dopaminergic neurons;
c) Schizophrenia;
d) Bipolar disorders/manic depression;
e) Cardiac disorders;
f) Myasthenia gravis;
g) Neuro-muscular disorders;
h) Cancerous and tumorous cells and related disorders;
i) HIV/AIDS and other immune or auto-immune system disorders;
j) Hepatic disorders;
k) Athletic conditioning;
l) Pathogen related conditions;
m) Viral, bacterial or other infectious diseases;
n) Leukemia;
o) Poisoning, including snakebite and other venom-based disorders;
p) Insulin-dependent diabetes;
q) Clinical trialling of drugs;
r) Any other instances of medication or drug administration to a subject, such that repeated doses are administered over time to maintain drug or ligand concentration to a desired level or within an interval of levels, in the presence of dissipative pharmacokinetic processes such as those of uptake or absorption, distribution or transport, metabolism or elimination;
s) Reconstruction of cardiac rhythms, function, arrhythmia or other cardiac output;
t) Drug-based control of arterial pressure.

23) A method according to claim 1, wherein the method includes, in the processing system, using the model to perform at least one of:
a) determining a health status of the subject;
b) diagnosing a presence, absence or degree of a condition;
c) treating a condition; and,
d) determining at least one biological attribute for the subject.

24) Apparatus for modelling the biological response of a biological subject, the apparatus including a processing system for:
a) for a model including one or more equations and associated parameters, comparing at least one measured subject attribute and at least one corresponding model value; and,
b) modifying the model in accordance with results of the comparison to thereby more effectively model the biological response.

25) A computer program product for modelling the biological response of a biological subject, the computer program product being formed from computer executable code, which when executed using a suitable processing system causes the processing system to:
a) for a model including one or more equations and associated parameters, compare at least one measured subject attribute and at least one corresponding model value; and,
b) modify the model in accordance with results of the comparison to thereby more effectively model the biological response.

26) A method for use in at least one of treating or diagnosing a subject, the method including modelling a biological response of a biological subject, using a processing system that:
a) for a model including one or more equations and associated parameters, compares at least one measured subject attribute and at least one corresponding model value;
b) modifies the model in accordance with results of the comparison to thereby more effectively model the biological response; and,
using the model to at least one of treat and diagnose a condition within the subject.
